(19) United States
(12) Patent Application Publication
(10) Pub. No.: US 2018/0075631 A1
(43) Pub. Date: Mar. 15, 2018

(54) HEAT MAP DISPLAY APPARATUS AND HEAT MAP DISPLAY METHOD

(71) Applicant: AZBIL CORPORATION, Chiyoda-ku (JP)

(72) Inventors: Tomomi OGATA, Chiyoda-ku (JP); Naoyuki Aota, Chiyoda-ku (JP)

(73) Assignee: AZBIL CORPORATION, Chiyoda-ku (JP)

(21) Appl. No.: 15/701,709

(22) Filed: Sep. 12, 2017

(30) Foreign Application Priority Data
Sep. 13, 2016 (JP) 2016-178493

(51) Int. Cl. G06T 11/20; G01K 3/14; G01K 1/02

(52) U.S. Cl. CPC G06T 11/206; G01K 1/026; G01K 3/14

(57) ABSTRACT

A heat map display apparatus includes a heat map display unit that displays a heat map based on a plurality of sets of data items collected from devices in a plant, each set of data items corresponding to a data series in a graph, an amount-of-change calculation unit that calculates, for each data series, amounts of time-series change in a set of data items on the basis of the sets of data items used to display the heat map, a target selection unit that selects a data series having a large amount of change in a set of data items on the basis of the calculated amounts of time-series change in the sets of data items, and a line graph display unit that displays, in association with the heat map, a line graph indicating the set of data items in the selected data series.

### CROSS-REFERENCE TO RELATED APPLICATIONS

The present application claims the benefit of priority to Japanese Application No. 2016-178493, filed Sep. 13, 2016, the entire contents of which are incorporated herein by reference.

### BACKGROUND

### 1. Field

The present disclosure relates to a heat map display apparatus and a heat map display method.

### 2. Description of the Related Art

A heat map is a visualization graph that represents the distribution of data by using color gradients. Using a heat map to display values measured by devices in a plant, for example, enables the state of a target being monitored in the plant to be discriminated by color. Japanese Unexamined Patent Application Publication No. 2009-075081 discloses a tool for displaying anomaly intensities and so on by using a heat map when a value that is an outlier, that is, anomalous, is detected for a device in power generation equipment.

When values measured by devices in a plant or the like are displayed using a heat map, values measured during the occurrence of an anomalous state, that is, anomalous values, as well as values measured in a steady state in a process are displayed as a heat map. When an anomalous value is detected, values including the anomalous value are displayed as a heat map. As a result, a wide range of measured values, including the anomalous value, is displayed as a heat map. As the range of measured values displayed as a heat map increases, the number of measured values represented in the same color increases accordingly. Thus, for instance, even when a detailed observation of a specific range within the range of normal values is desired, the measured values in the specific range and measured values in other, preceding and subsequent ranges are leveled out and are processed in the same color, which may make a change between the range to be observed and other ranges obscure and inconspicuous. This will be specifically described with reference to FIGS. 7A and 7B.

FIGS. 7A and 7B illustrate an example of color bars of heat maps. Color bars CA and CB are each scaled from 0 to 110, and the color maps are color-coded using gradations of colors. FIG. 7A exemplarily illustrates the color bar CA in a steady state during plant control, and FIG. 7B exemplarily illustrates the color bar CB in a state where an anomalous value occurs during plant control. In the color bar CA illustrated in FIG. 7A in the steady state, the maximum value of data is 50 and a portion of the color map at a scale equal to or less than 50 is substantially color-coded. In contrast, in a state where an anomalous value of 100 occurs, as depicted in the color bar CB illustrated in FIG. 7B, a portion of the color map at a scale equal to or less than 100 is substantially color-coded.

For instance, the range of 25 to 35 is to be observed. In the color bar CA illustrated in FIG. 7A, the range of 20 to 30 and the range of 30 to 40 are indicated by different colors and a change between the ranges is observable. In the color bar CB illustrated in FIG. 7B, in contrast, the range of 20 to 40 is indicated by the same color and a change within the range to be observed is thus obscure and inconspicuous. In this case, it is difficult to identify the state to be monitored by using colors.

### SUMMARY

Embodiments of the present disclosure provide a heat map display apparatus and a heat map display method that facilitate identification of the state to be monitored.

According to an aspect of the present disclosure, a heat map display apparatus includes a heat map display unit that displays a heat map based on a plurality of sets of data items collected from devices in a plant, each set of data items corresponding to a data series in a graph, an amount-of-change calculation unit that calculates, for each data series, amounts of time-series change in a set of data items on the basis of the sets of data items used to display the heat map, a target selection unit that selects a data series having a large amount of change in a set of data items on the basis of the calculated amounts of time-series change in the sets of data items, and a line graph display unit that displays, in association with the heat map, a line graph indicating the set of data items in the selected data series.

The sets of data items may be each a set of fixed-interval data items for each predetermined interval, the amount-of-change calculation unit may calculate amounts of change across fixed-interval data items that are temporally consecutive, and the target selection unit may select a data series having an absolute value that is largest among absolute values of the calculated amounts of change across the fixed-interval data items within a predetermined period.

The target selection unit may select a data series in terms of either an increase or decrease in the calculated amounts of change across the fixed-interval data items.

The target selection unit may determine, for each data series, a cumulative absolute value of amounts of time-series change in the set of data items within a predetermined period and select a data series having a cumulative absolute value that is largest.

The target selection unit may select a data series in terms of either an increase or decrease in the amounts of change in the sets of data items.

According to another aspect of the present disclosure, a heat map display method includes a heat map display step of displaying a heat map based on a plurality of sets of data items collected from devices in a plant, each set of data items corresponding to a data series in a graph, an amount-of-change calculation step of calculating, for each data series, amounts of time-series change in a set of data items on the basis of the sets of data items used to display the heat map, a target selection step of selecting a data series having a large amount of change in a set of data items on the basis of the calculated amounts of time-series change in the sets of data items, and a line graph display step of displaying, in association with the heat map, a line graph indicating the set of data items in the selected data series.

According to embodiments of the present disclosure, it is possible to provide a heat map display apparatus and a heat map display method that facilitate identification of the state to be monitored.

### BRIEF DESCRIPTION OF THE DRAWINGS

FIG. 1 is an exemplary illustration of a configuration of a heat map display apparatus according to a first embodiment;

FIG. 2 is an exemplary illustration of a heat map according to the first embodiment;

FIG. 3 is an exemplary illustration of line graphs for individual temperature sensors according to the first embodiment;

FIG. 4 is an illustration of the display of the heat map and a line graph according to the first embodiment in association with each other;

FIG. 5 is an exemplary illustration of line graphs for individual temperature sensors according to a second embodiment;

FIG. 6 is an illustration of the display of a heat map and a line graph according to the second embodiment in association with each other;

FIG. 7A is an exemplary illustration of a color bar in a steady state during plant control;

FIG. 7B is an exemplary illustration of a color bar in a state where an anomalous value occurs during plant control; and

FIG. 8 is an illustration of the display of a heat map and a line graph according to a modification in association with each other.

### DESCRIPTION OF THE PREFERRED EMBODIMENTS

Embodiments of the present disclosure will be described hereinafter with reference to the drawings. The following embodiments are for illustrative purposes only, and a variety of modifications or applications of techniques that are not explicitly described below are not to be excluded. That is, embodiments of the present disclosure can be modified in a variety of ways without departing from the spirit of the disclosure.

### First Embodiment

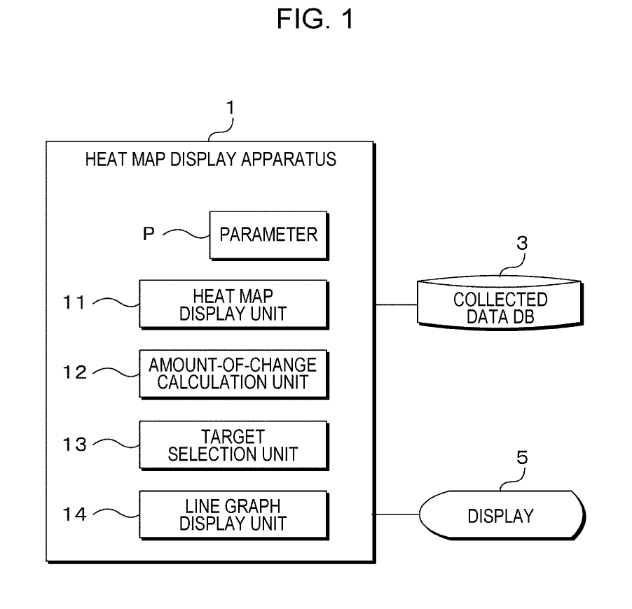

A configuration of a heat map display apparatus according to a first embodiment will be described with reference to FIG. 1. As illustrated in FIG. 1, a heat map display apparatus 1 functionally includes, for example, a heat map display unit 11, an amount-of-change calculation unit 12, a target selection unit 13, and a line graph display unit 14. The details of these components will be described below.

The heat map display apparatus 1 physically includes, for example, a central processing unit (CPU), a memory, and an input/output interface. The memory includes elements such as a read only memory (ROM) or a hard disk drive (HDD) that stores programs and data to be processed by the CPU and a random access memory (RAM) mainly used as various work areas for control processes. These elements are connected to one another via a bus. The CPU executes a program stored in the ROM and processes data received via the input/output interface or data loaded onto the RAM, thereby implementing the functions of the individual components of the heat map display apparatus 1.

Referring to FIG. 1, a collected data database (DB) 3 is a database that stores various kinds of data collected from various devices in a plant, for example.

Examples of the various devices in the plant include a device having a highway addressable remote transducer (HART) communication function, and a device supporting the Foundation (registered trademark) Fieldbus (FF) technology.

Specifically, various sensor devices for detecting temperatures, pressures, flow rates, and so on, valve positioners for controlling various valves such as a pressure control valve and a flow control valve, various actuators for allowing a pump, a fan, and so on to operate, and other devices can be used as devices. The various kinds of data include, for example, measurement data such as temperatures, pressures, and flow rates, and control data such as the openings of valves. The measurement data and the control data are stamped with the time of measurement and the time of control, respectively.

The heat map display unit 11 illustrated in FIG. 1 displays on a display 5 a heat map based on the data collected from the devices in the plant. The heat map is a visualization graph that represents the distribution of target data by using gradations of colors, and represents, for example, the states of numerical values (measured values) of a target device over each target period (e.g., each month) by using colors. In this embodiment, the data collected from the devices will be described, taking temperature data collected from temperature sensors as an example.

The data collected from the devices, which is not limited to temperature data collected from the temperature sensors, may be information having similar features (e.g., data obtained at a plurality of measurement points in the same control system) and may be set as a parameter P by an administrator (user), as desired. Instead of temperature data collected from the temperature sensors described above, by way of example, valve opening data collected from valve positioners may be used. The target period or the target device may be optionally set as a parameter P by the administrator.

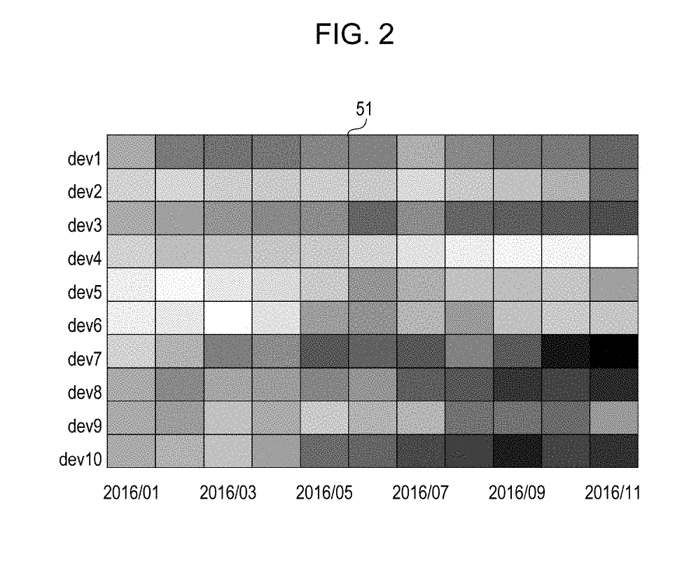

FIG. 2 represents an example of a heat map. In a heat map 51 illustrated in FIG. 2, the horizontal axis represents dates in year/month format (e.g., 2016/1 (January 2016) to 2016/11 (November 2016)) and the vertical axis represents temperature sensors (e.g., dev1 to dev10). In the heat map 51, areas are each plotted on a graph in a color associated with a temperature (measured value) determined by the corresponding date in year/month format and the corresponding temperature sensor.

The amount-of-change calculation unit 12 calculates, for each temperature sensor, amounts of time-series change in data on the basis of the data used for displaying the heat map. This will be specifically described.

In the first embodiment, data used for displaying a heat map is, for example, fixed-interval monthly data. The interval used for the fixed-interval data is not limited to months but may be any predetermined interval, and the administrator can optionally set the interval as a parameter P. The amount-of-change calculation unit 12 calculates, for each temperature sensor, amounts of change across fixed-interval data that is temporally consecutive. That is, the amount-of-change calculation unit 12 sequentially calculates, for each temperature sensor, amounts of change over individual months.

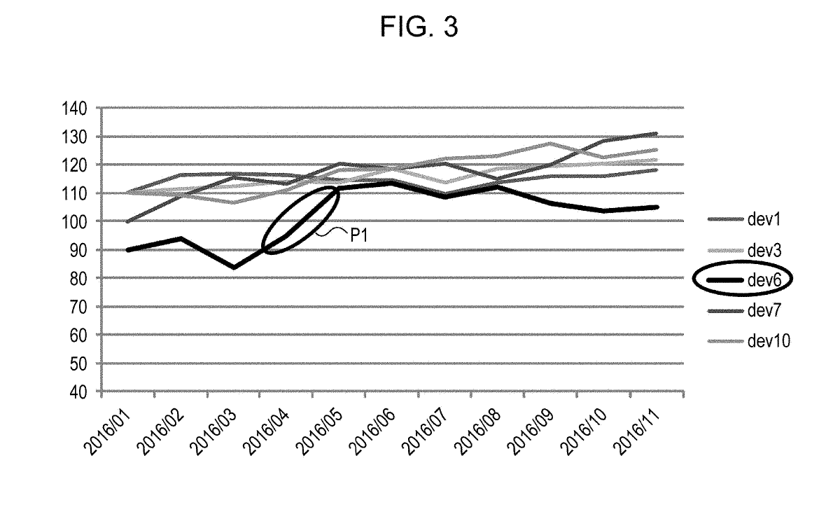

The target selection unit 13 selects a temperature sensor associated with the largest absolute value among the absolute values of the amounts of change over individual months calculated by the amount-of-change calculation unit 12, as a device of interest for which the largest change in temperature is obtained. This will be specifically described with reference to FIG. 3.

FIG. 3 depicts line graphs each representing a monthly progression of values measured by one of the temperature sensors dev1, dev3, dev6, dev7, and dev10 over the period of January 2016 (2016/1) to November 2016 (2016/11) (i.e., within a predetermined period). In this case, as indicated by P1, the absolute value of the amount of change in the value measured by the temperature sensor dev6 over the period from March 2016 (2016/3) to April 2016 (2016/4) and the absolute value of the amount of change in the value measured by the temperature sensor dev6 over the period from April 2016 (2016/4) to May 2016 (2016/5) are the largest. That is, a line graph portion indicated by P1 is a portion having the largest absolute value among the absolute values of the amounts of change over individual months. Accordingly, the temperature sensor dev6 is selected as the device of interest.

The device of interest may be selected in terms of either the increase or decrease in the amounts of change over individual months in accordance with the usage of the device or the like.

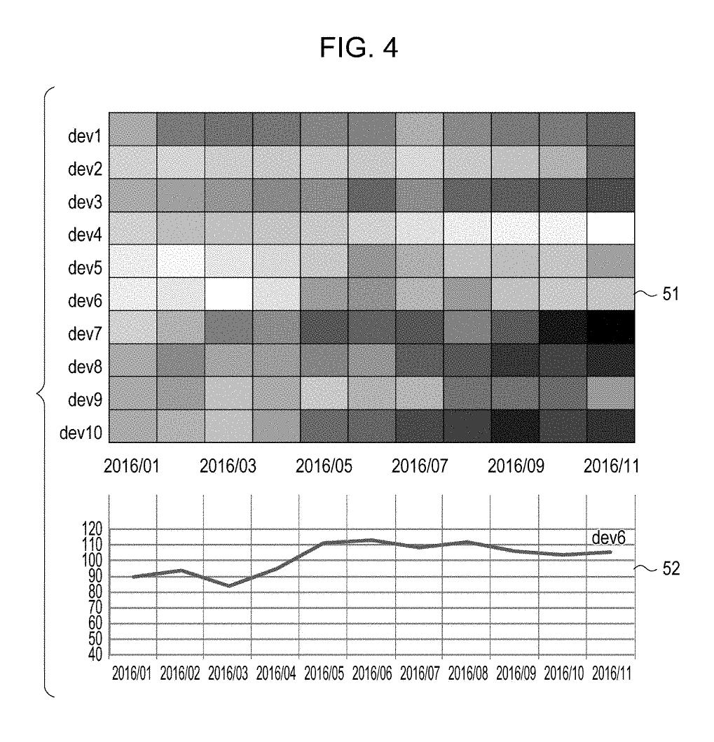

The line graph display unit 14 displays on the display 5 a line graph associated with the data obtained by the selected temperature sensor. This line graph is displayed in association with a heat map. This will be specifically described with reference to FIG. 4.

FIG. 4 is a diagram illustrating an example of the display of the heat map 51 and a line graph 52 in association with each other. In the heat map 51, the horizontal axis represents dates in year/month format (e.g., 2016/1 (January 2016) to 2016/11 (November 2016)) and the vertical axis represents temperature sensors (e.g., dev1 to dev10). In the line graph 52, the horizontal axis represents dates in year/month format (e.g., 2016/1 (January 2016) to 2016/11 (November 2016)) and the vertical axis represents temperatures in Celsius (° C.). That is, the heat map 51 and the line graph 52 illustrated in FIG. 4 are presented in association with each other with the scales on the horizontal axes aligned.

As described above, the heat map display apparatus 1 according to the first embodiment can display a heat map based on fixed-interval data collected from a plurality of temperature sensors in a plant, calculate, for each temperature sensor, amounts of change across fixed-interval data that is temporally consecutive on the basis of the fixed-interval data used to display the heat map, select a temperature sensor for which the absolute value of the calculated amount of change across fixed-interval data is largest within a predetermined period, and display, in association with the heat map, a line graph indicating the data obtained by the selected temperature sensor.

With this configuration, a temperature sensor used to obtain the largest amount of change in data can be selected, and a line graph indicating the selected temperature sensor can be displayed in association with a heat map. This can reduce the probability of the state to be focused being missed. That is, the heat map display apparatus 1 according to the first embodiment can facilitate identification of the state to be monitored.

### Second Embodiment

A second embodiment of the present disclosure will be described. A heat map display apparatus 1 according to the second embodiment is different from the heat map display apparatus 1 according to the first embodiment described above in that the amount-of-change calculation unit 12 and the target selection unit 13 according to the second embodiment have functions different from those according to the first embodiment. Other configuration is similar to that of the heat map display apparatus 1 according to the first embodiment. Constituent elements having similar configurations are identified with the same numerals and are not described herein. In the following, a description is given of mainly the differences from the first embodiment.

In the first embodiment described above, data used for displaying a heat map is fixed-interval data, whereas in the second embodiment, data used for displaying a heat map is not necessarily fixed-interval data. In addition, the amount-of-change calculation unit 12 according to the first embodiment calculates, for each temperature sensor, amounts of change across fixed-interval data that is temporally consecutive, whereas the amount-of-change calculation unit 12 according to the second embodiment calculates, for each temperature sensor, amounts of time-series change in data on the basis of the data used for displaying the heat map.

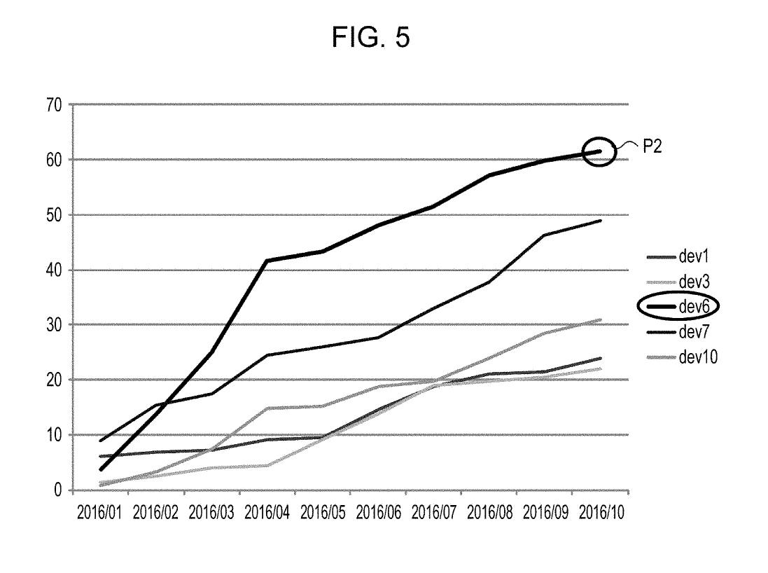

Furthermore, the target selection unit 13 according to the first embodiment described above selects a temperature sensor associated with the largest absolute value among the absolute values of the amounts of change over individual months calculated by the amount-of-change calculation unit 12 within a predetermined period, as a target of interest for which the largest change in temperature is obtained, whereas the target selection unit 13 according to the second embodiment determines, for each temperature sensor, a cumulative absolute value of amounts of time-series change in data within a predetermined period and selects a temperature sensor associated with the largest cumulative absolute value, as a target of interest for which the largest change in temperature is obtained. This will be specifically described with reference to FIG. 5.

FIG. 5 depicts line graphs each representing a cumulative absolute value of the amounts of change in data obtained by one of the temperature sensors dev1, dev3, dev6, dev7, and dev10 over the period of January 2016 (2016/1) to October 2016 (2016/10) (i.e., within a predetermined period). In this case, a value indicated by P2, which is determined by accumulating values of data obtained by the temperature sensor dev6 over the period from January 2016 (2016/1) to October 2016 (2016/10) in chronological order is the largest. Accordingly, the temperature sensor dev6 is selected as the device of interest.

The device of interest may be selected in terms of either the increase or decrease in the amount of change in data in accordance with the usage of the device or the like.

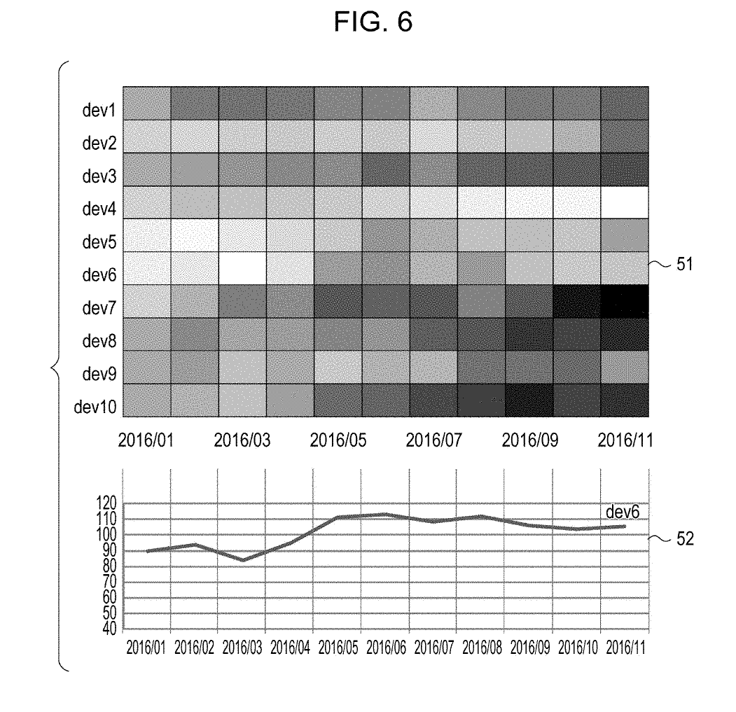

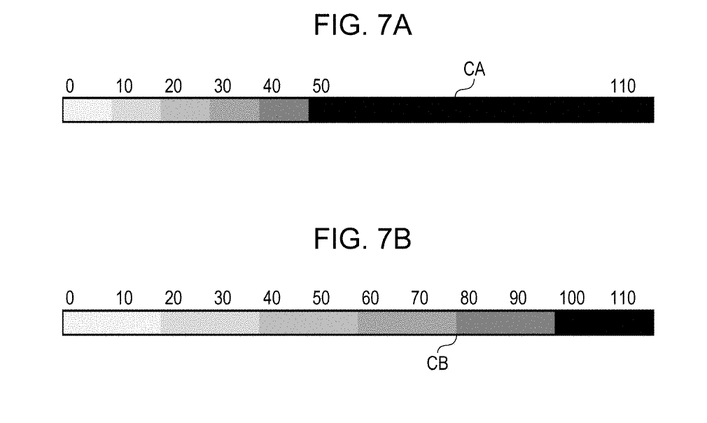

FIG. 6 is a diagram illustrating an example of the display of a heat map 51 and a line graph 52 in association with each other according to the second embodiment. In the heat map 51, the horizontal axis represents dates in year/month format (e.g., 2016/1 (January 2016) to 2016/11 (November 2016)) and the vertical axis represents temperature sensors (e.g., dev1 to dev10). In the line graph 52, the horizontal axis represents dates in year/month format (e.g., 2016/1 (January 2016) to 2016/11 (November 2016)) and the vertical axis represents temperatures in Celsius (° C.). That is, the heat map 51 and the line graph 52 illustrated in FIG. 6 are presented in association with each other with the scales on the horizontal axes aligned.

As described above, the heat map display apparatus 1 according to the second embodiment can display a heat map based on data collected from a plurality of temperature sensors in a plant, calculate, for each temperature sensor, amounts of time-series change in data on the basis of the data used for displaying the heat map, determine, for each temperature sensor, a cumulative absolute value of the calculated amounts of time-series change in data, select a temperature sensor associated with the largest cumulative absolute value, and display, in association with the heat map, a line graph indicating the data obtained by the selected temperature sensor.

With this configuration, a temperature sensor associated with the largest cumulative value of amounts of change in data can be selected, and a line graph indicating the selected temperature sensor can be displayed in association with a heat map. This can reduce the probability of the state to be focused being missed. That is, the heat map display apparatus 1 according to the second embodiment can facilitate identification of the state to be monitored.

### MODIFICATIONS

In the embodiments described above, temperature sensors are represented on the vertical axis of the heat map displayed by the heat map display unit 11. However, this is not to be taken in a limiting sense. For example, the vertical axis of a heat map may represent temperature segments of temperature sensors. In this case, the heat map display unit 11 displays a heat map by using a plurality of pieces of data collected from a single temperature sensor. For instance, a heat map can be displayed in such a manner that, for each target period (e.g., each month), the probabilities that the value measured by a target temperature sensor falls within the respective temperature segments are represented by colors.

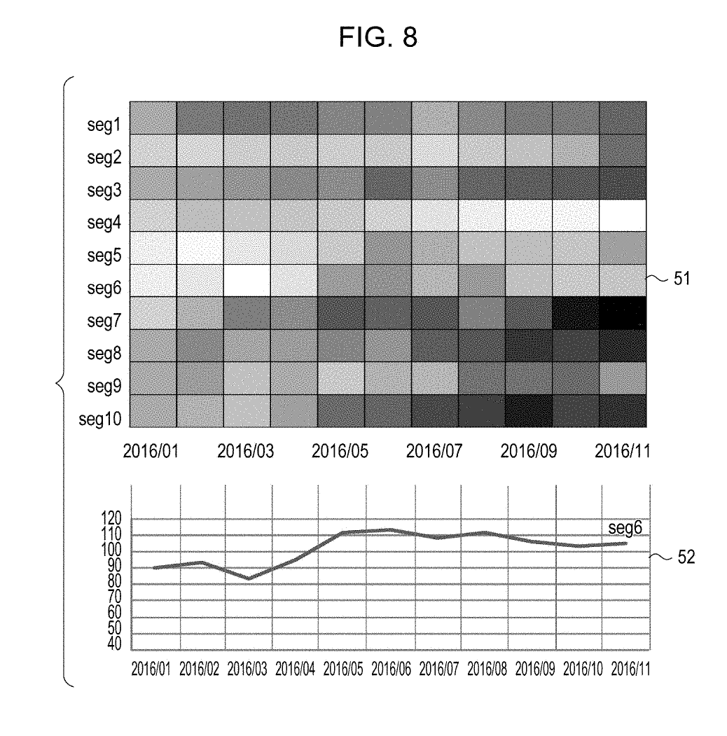

FIG. 8 is a diagram illustrating an example of the display of a heat map 51 and a line graph 52 in association with each other according to a modification. In the heat map 51, the horizontal axis represents dates in year/month format (e.g., 2016/1 (January 2016) to 2016/11 (November 2016)) and the vertical axis represents temperature segments (e.g., seg1 to seg10) of temperature sensors. In the line graph 52, the horizontal axis represents dates in year/month format (e.g., 2016/1 (January 2016) to 2016/11 (November 2016)) and the vertical axis represents temperatures in Celsius (° C.). That is, the heat map 51 and the line graph 52 illustrated in FIG. 8 are presented in association with each other with the scales on the horizontal axes aligned.

What is claimed is:

1. A heat map display apparatus comprising:
a heat map display unit that displays a heat map based on a plurality of sets of data items collected from devices in a plant, each set of data items corresponding to a data series in a graph;
an amount-of-change calculation unit that calculates, for each data series, amounts of time-series change in a set of data items on the basis of the sets of data items used to display the heat map;
a target selection unit that selects a data series having a large amount of change in a set of data items on the basis of the calculated amounts of time-series change in the sets of data items; and
a line graph display unit that displays, in association with the heat map, a line graph indicating the set of data items in the selected data series.

2. The heat map display apparatus according to claim 1, wherein
the sets of data items are each a set of fixed-interval data items for each predetermined interval,
the amount-of-change calculation unit calculates amounts of change across fixed-interval data items that are temporally consecutive, and
the target selection unit selects a data series having an absolute value that is largest among absolute values of the calculated amounts of change across the fixed-interval data items within a predetermined period.

3. The heat map display apparatus according to claim 2, wherein
the target selection unit selects a data series in terms of either an increase or decrease in the calculated amounts of change across the fixed-interval data items.

4. The heat map display apparatus according to claim 1, wherein
the target selection unit determines, for each data series, a cumulative absolute value of amounts of time-series change in the set of data items within a predetermined period and selects a data series having a cumulative absolute value that is largest.

5. The heat map display apparatus according to claim 4, wherein
the target selection unit selects a data series in terms of either an increase or decrease in the amounts of change in the sets of data items.

6. A heat map display method comprising:
a heat map display step of displaying a heat map based on a plurality of sets of data items collected from devices in a plant, each set of data items corresponding to a data series in a graph;
an amount-of-change calculation step of calculating, for each data series, amounts of time-series change in a set of data items on the basis of the sets of data items used to display the heat map;
a target selection step of selecting a data series having a large amount of change in a set of data items on the basis of the calculated amounts of time-series change in the sets of data items; and
a line graph display step of displaying, in association with the heat map, a line graph indicating the set of data items in the selected data series.
